(19) United States
(12) Patent Application Publication
(10) Pub. No.: US 2005/0154708 A1
(43) Pub. Date: Jul. 14, 2005

(54) Information exchange between heterogeneous databases through automated identification of concept equivalence

(76) Inventor: Yao Sun, West Roxbury, MA (US)

Correspondence Address: Guerin & Rodriquez;Patent Administrator, 5 Mount Royal Avenue, Marlborough, MA, 01752, US

(21) Appl. No.: 10/502,876

(22) PCT Filed: Jan. 29, 2003
(86) PCT No.: PCT/US03/02604

Related U.S. Application Data
(60) Provisional application No. 60/352,163, filed on Jan. 29, 2002.

(51) Int. Cl. G06F 7/00

(52) U.S. Cl. 707/3

(57) ABSTRACT

Described are a system and methods for exchanging information between heterogeneous databases (28,28′). A constructor (54) produces a first semantic network (58) representation of a first database (28). A concept matcher (52) identifies semantic concept equivalencies (64) between the semantic network (58) representation of the first database (28) and a second semantic network (58′) representation of the second database (28′). A query processor (66) uses one of the identified semantic concept equivalencies (64,64′) to generate a request to access data from the second database (28).

### RELATED APPLICATIONS

This application claims the benefit of the filing date of co-pending U.S. Provisional Application Ser. No. 60/352,163, filed Jan. 29, 2002, titled “The Medical Information Acquisition and Transmission Enabler (MEDIATE),” the entirety of which provisional application is incorporated by reference herein.

### FIELD OF THE INVENTION

The invention relates generally to database systems. More particularly, the invention relates to a system and method for exchanging information between heterogeneous databases.

### BACKGROUND

The ability to access the entire medical record of a patient offers tantalizing possibilities for improving clinical care and supporting medical research. Patients often, however, receive their medical care from multiple health care providers or facilities. Further, each health care provider or facility electronically records patient data in its own information system. Typically, these information systems record different data using different data structures at different levels of granularity. Each may even use a different nomenclature to identify similar clinical concepts. Consequently, the complete electronic medical record for any given patient is usually scattered across multiple heterogeneous information systems. Semantic inconsistencies between the information systems present a formidable obstacle to integrating the clinical information.

Various approaches have arisen to address the problem of semantic inconsistencies between information systems. One such approach utilizes a common data model. For common data model systems, information from heterogeneous information systems is mapped to a common model. A common model can work well if the model is comprehensive (as in small knowledge domains) and requires infrequent modification. In some domains, however, such as the medical record domain, repeated attempts at creating a comprehensive data model have not gained widespread acceptance.

A disadvantage of common data models is that modifications to the common model involve modifications to the data mapping process for every database involved in data exchange. This tends to be problematic when new databases are added, and deleteriously affects the scalability of such systems. Another disadvantage is that the data mapping process can cause a loss of information as data concepts are force-fit to the common model. This affects the semantic fidelity of information transmitted through these systems.

Another approach to addressing the problem of semantic inconsistencies involves the development of federated database architectures. A federated system attempts to support local database operational autonomy within a system that allows information sharing among interconnected databases. An objective of a federated system is to present a common interface for queries and transactions which are eventually executed by a local database. To create the common interface, a federated system integrates or reconciles the database schemas of its component databases, which can occur at various levels of abstraction (e.g. local, component, export, etc.).

As with common data models, lack of scalability is also a disadvantage of federated systems. Whenever a new database is added, schemas must be integrated, often at multiple levels. If the new database offers unique information that must be available to all users, all levels of the federated architecture are affected because of the schema dependencies.

There remains, therefore, a need for a scalable system that allows information exchange without the need to fit the information into a static data model or into a central schema framework.

### SUMMARY

In one aspect, the invention features a system for exchanging information between a first database and a second database. The system includes a constructor for producing a first semantic network representation of the first database. A concept matcher identifies semantic concept equivalencies between the semantic network representation of the first database and a semantic network representation of the second database. A query processor uses one of the identified semantic concept equivalencies to generate a request to access data from the second database.

In another aspect, the invention features a method for exchanging data between databases. A first semantic network representation of a first database is generated. A second semantic network representation of a second database is received. Semantic concept equivalencies between the first and second semantic network representations are identified. A request to retrieve information from the second database is produced using at least one of the identified semantic concept equivalencies.

In yet another aspect, the invention features a method of exchanging data between databases. A semantic network representation of a first database is generated. A request is received from a remote database system to retrieve information from the first database. The request identifies a node of the semantic network representation. Information is retrieved from the first database using a query formulated from information associated with the node of the semantic network representation.

### BRIEF DESCRIPTION OF THE DRAWINGS

The above and further advantages of this invention may be better understood by referring to the following description in conjunction with the accompanying drawings, in which like numerals indicate like structural elements and features in various figures. The drawings are not necessarily to scale, emphasis instead being placed upon illustrating the principles of the invention.

FIG. 1 is a block diagram of an embodiment of a system for exchanging information between heterogeneous databases in accordance with the principles of the invention.

FIG. 2 is a block diagram of an embodiment of a system architecture used to exchange information between heterogeneous databases in accordance with the principles of the invention.

FIG. 3 is a diagram of a simplified embodiment of a semantic concept equivalencies table of the present invention.

FIG. 4 is a flow chart illustrating an embodiment of a process for exchanging information between databases in accordance with the present invention.

FIG. 5 is a flow chart illustrating another embodiment of a process for exchanging information between databases.

FIG. 6 is a diagram illustrating an oversimplified example of a semantic network of the present invention.

FIG. 7 is a diagram illustrating an embodiment of a node in a semantic network of the present invention and the informational content of that node.

FIG. 8 is a screen shot of a graphical user interface window showing an embodiment of a semantic network in a first sub-window and a list of user activities in a second sub-window.

FIG. 9 is a screen shot of the second sub-window with the “edit UMLS links” activity selected.

FIG. 10 is a flow chart illustrating an embodiment of a process for matching concepts between semantic network representations in accordance with the present invention.

FIG. 11 is a diagram illustrating an embodiment of a matching algorithm used to match concepts between semantic network representations in accordance with the present invention.

FIG. 12 is a screen shot of semantic networks and matching nodes.

FIG. 13 is a screen shot of a graphical user interface window used to link nodes to database elements.

FIG. 14 is a screen shot of a graphical user interface window used to formulate a query to retrieve data elements from the remote database.

FIG. 15A is a diagram illustrating an example of a concept-match retrieval process for retrieving data elements from the remote database.

FIG. 15B is a diagram illustrating an example of a leaf-match retrieval process for retrieving data elements from the remote database.

### DETAILED DESCRIPTION

In brief overview, the present invention facilitates information exchange between disparate or heterogeneous databases by identifying semantically equivalent concepts between the databases and formulating queries using the semantically equivalent concepts to access data in the databases. The present invention is not intended to be limited to those embodiments described herein. For example, although the following description refers primarily to medical databases for illustrating the invention, the principles of the invention apply also to other types of databases.

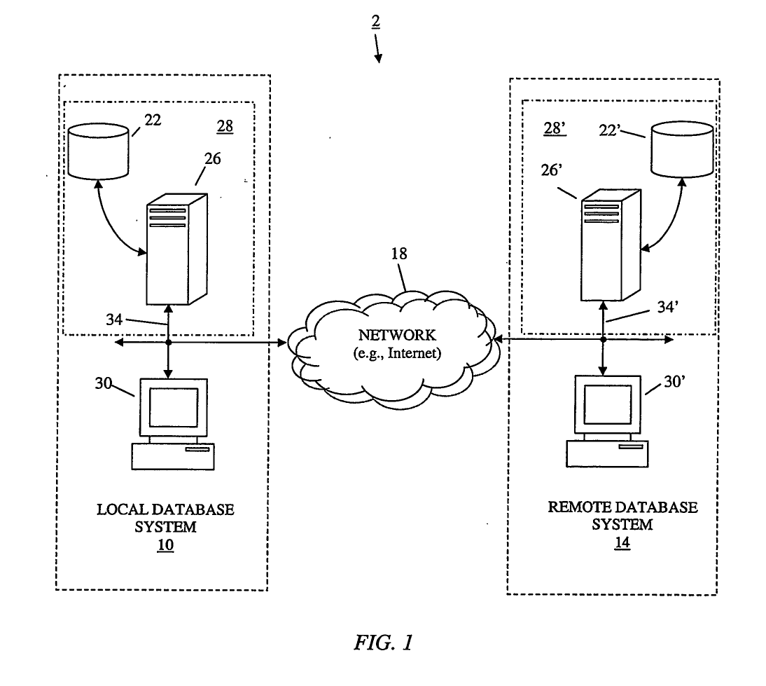

FIG. 1 shows an example of a network environment 2 in which information is exchanged between databases in accordance with the principles of the invention. The network environment 2 includes a first database system 10 and a second database system 14 in communication with each other over a network 18. Example embodiments of the network 18 include the Internet, an intranet, a local area network (LAN), a wide area network (WAN), and a virtual private network (VPN). For purposes of illustrating the invention, the first database system 10 is referred to as a local database system and the second database system 10 as a remote database system.

Each database system 10, 14, respectively, includes a data store 22, 22′, a database server 26, 26′, and a client computer 30, 30′. Each data store 22, 22′ (generally, data store 22) physically stores a set of records. Each database server 26, 26′ (generally, database server 26) is connected to the respective data store 22, 22′ and, with that respective data store 22, 22′, provides a database 28, 28′, respectively. Each data store 22 can be external or internal to the database server 26. In one embodiment, the databases 28, 28′ are relational databases. Other types of databases, such as flat-file databases, can be used without departing from the principles of the invention. Herein, the database 28 provided by the database server 26 and data store 22 is referred to as a local database 28, and the database 28′ provided by the database server 26 and data store 22′ as a remote database 28′. The databases 28, 28′ can be homogeneous, however the advantages of the present invention are realized when the databases 28, 28 are heterogeneous. Heterogeneity between the databases 28, 28′ can be at one or more levels; for example, the databases 28, 28′ can have different schemas, store different data, use different data structures, use different naming conventions or codes, or any combination thereof.

Each client computer 30, 30′ (generally, client 30) is connected to the respective database server 26, 26′ by a respective local network 34, 34′. Installed on each client 30 is software for performing information exchange of the present invention between the databases 28,28′. In one embodiment, the software is implemented in the JAVA™ programming language, which is portable across different operating systems and possesses network and database capabilities. Other program languages are suitable for implementing the present invention. Through execution of the software on the client 30, a user has access to information in the local database 28 and in the remote database 28′ through an exchange of information achieved in accordance with the principles of the invention.

To communicate information across the network 18, in one embodiment, the clients 30, 30′ use standard transport protocols, such as TCP/IP and the hypertext transfer protocol (HTTP). Also, for embodiments in which the databases 28, 28′ are medical databases, Health Level 7 (HL7) provides a standard communications protocol for exchanging medical information messages between medical information systems. The HL7 standard is an American National Standard for electronic data exchange in health care that standardizes the communication protocol for clinical and administrative information. In one embodiment, the HL7 messages exchanged between databases systems 10, 14 are encoded as Extensible Markup Language (XML) documents. XML documents use XML field tags to represent medical data and define medical concept relationships. The XML document type definition, or XML schema, defines the particular meaning of each XML field tag. The HL7 messages are transferred across the network 18 using the transport protocol.

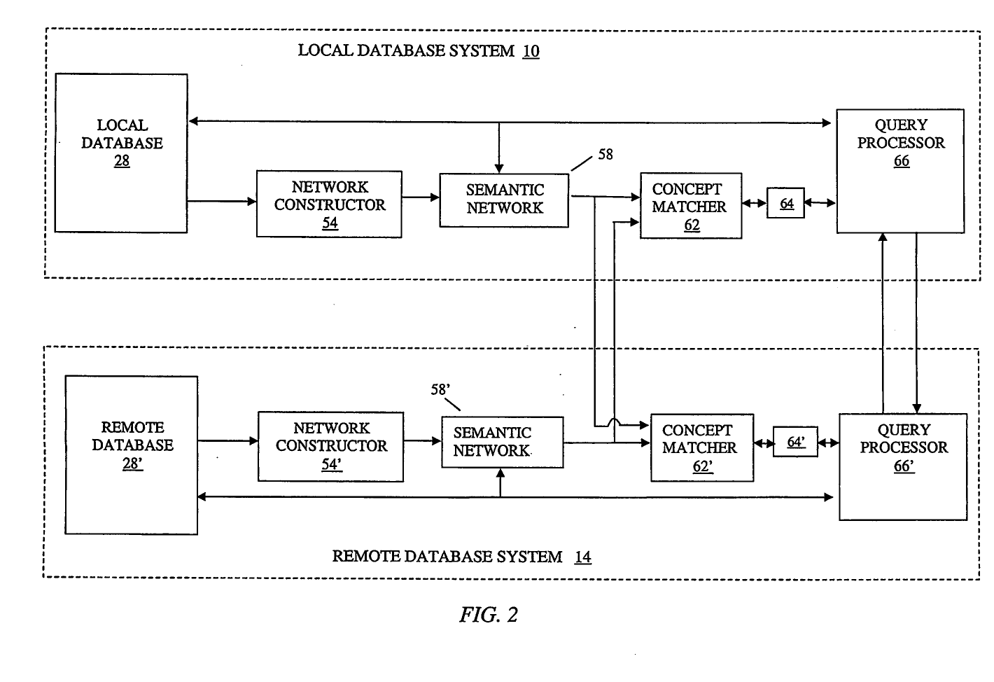

FIG. 2 shows an embodiment of a system architecture used to achieve the exchange of information between databases in accordance with the principles of the invention. Referring to the local database system 10, the system architecture includes a network constructor 54, a concept matcher 62, and a query processor 66. The remote database system 14 has similar components as the local database system 10, with similar components being so indicated with a prime (′) designation. In general, the semantic network 58, concept matcher 62, and query processor 66 present an interface for routing communications to other databases.

The network constructor 54 is in communication with the local database 28 and includes a set of routines that enable users to build the semantic network representation 58 of the local database 28 using system-defined conceptual relationships, as described in more detail below. Similarly, the network constructor 54′ has routines that build a semantic network representation 58′ of the remote database 28′. Each semantic network representation 58 models the underlying database 28, 28′ using a directed acyclic graph (e.g., a tree) with nodes that represent concepts and links that represent relationships between concepts.

The routines of each network constructor 54, 54′ are capable of accessing and reading information from the underlying database and converting that information into the structure of the acyclic graph. Depending upon the type of databases (e.g., relational, flat-file, etc.), the routines of the network constructor 54 can be the same as or differ from the routines of the remote network constructor 54′. The data structures used to represent the semantic network representations 58, 58′ are stored in memory. In one embodiment, the semantic network representations 58, 58′ generated by the respective network constructors 54, 54′ are stored with the respective database 28, 28′.

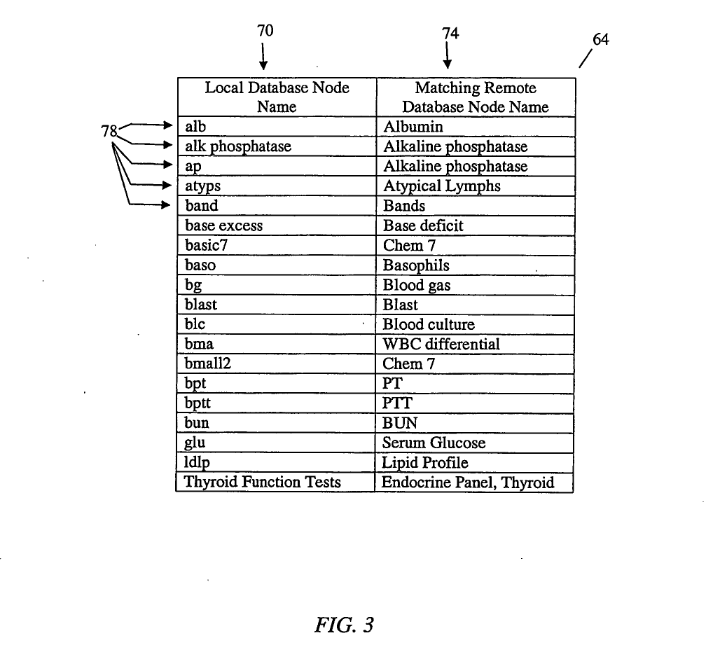

The concept matcher 62 receives as input the semantic network representation 58 of the local database 28 and the semantic network representation 58′ of the remote database 28′ and identifies semantic concept equivalencies between the two representations 58, 58′. Two concepts in the two different semantic network representations 58, 58′ are inferred to be semantically equivalent to each other if the concept matcher 62 identifies the two corresponding nodes as the output of a match. Semantic equivalence implies some degree of commonality in the semantic context of two nodes (i.e., one in the local semantic network representation 58 and one in the remote semantic network representation 58′). Both nodes have some information content in common. Note that semantic equivalence is not the same as “terminological equivalence”. Nodes can be semantically equivalent although terminologically different. For example (see FIG. 3), a match between a remote node named “WBC differential” and a local node named “bma” indicates that the nodes, although terminologically dissimilar, have semantically equivalent content (e.g., at a subcomponent level—described in more detail below).

The concept matcher 62 produces a table 64 of semantic concept equivalencies found between the two inputted semantic network representations 58, 58′. Similarly, the concept matcher 62′ of the remote database system 14 receives as input the semantic network representation 58′ of the remote database 28′ and the semantic network representation 58 of the local database 28′ and produces a table 64′ of semantic concept equivalencies detected from the two inputted semantic network representations 58, 58′.

FIG. 3 shows a simplified embodiment of the table 64 of semantic concept equivalencies. Typically, the table 64 includes hundreds or thousands of matching concepts. One column 70 of the table 64 identifies a node of the local semantic network representation 58 and a second column 74 identifies a matching node of the remote semantic network representation 58′. Each entry 78 in the table 64 represents semantically equivalent concepts between the two databases 28, 28′. Each entry of the table 64′ at the remote database system 14 has similarly matching concepts, but the columns are in reverse order. In another embodiment, the table 64 is a hash table. As described in more detail below, concept matching algorithms access the table 64 to obtain previously matched concepts and use such matched concepts to identify additional matching concepts.

Returning to FIG. 2, the query processor 66 is in communication with the table 64 and with the local database 28, and with the query processor 66′ of the remote database system 14. The query processor 66′ of the remote database system 14 is also in communication with the remote database 28 and the table 64′. Database information exchange occurs between the query processors 66, 66′, as described in more detail below.

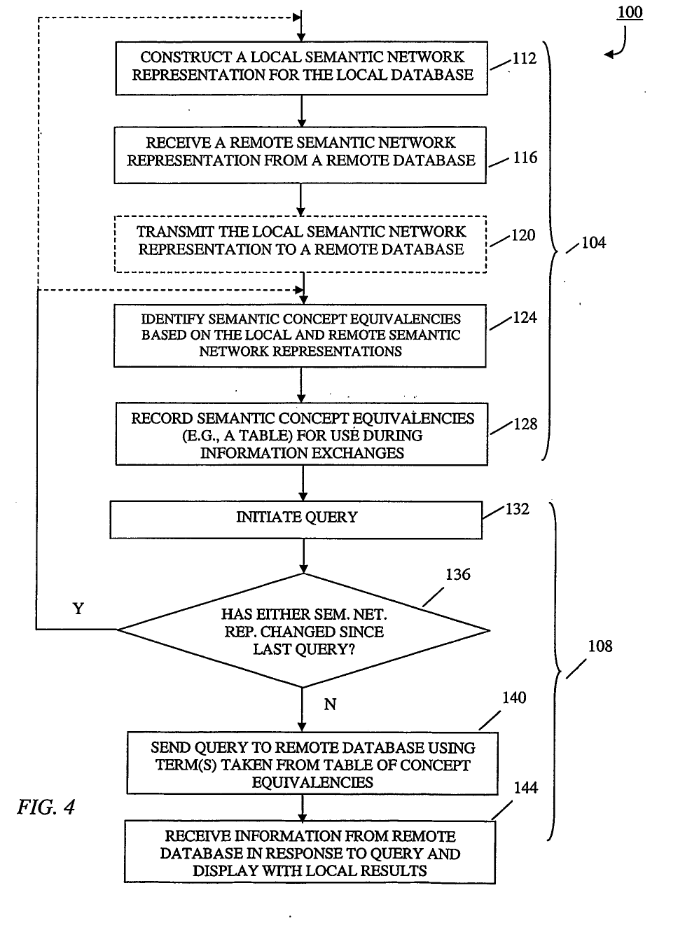

FIG. 4 shows an embodiment of a process 100 for exchanging information between the local database system 10 and the remote database system 14. This information exchange, as described herein, is from the perspective of the local database system 10, with the transfer of database information coming from the remote database system 14 and data integration occurring at the local database system 10. Reference is made also to the system components described in FIG. 2.

The process 100 includes a preparation stage 104 and an information exchange stage 108. During the preparation stage 104, the network constructor 54 constructs (step 112) a semantic network representation 58 of the local database 28. The network constructor 54 also allows dynamic reconstruction of the semantic network representation 58 if the local database 28 changes, without affecting the remote database 28′. The local database system 10 also receives (step 116) the semantic network representation 58′ of the remote database 28′ over the network 18 from the remote database system 14.

Optionally, as indicated by dashed lines, the local database system 10 transmits (step 120) the semantic network representation 58 to the remote database system 14 (so that the remote database system 14 can obtain information from the local database system 10 similarly to the local database system 10 obtaining information from the remote database system 14, as described herein). The local database system 10 can perform this transmission automatically, upon generating the semantic network representation 58, or when sending a request to obtain data from the remote database system 14. The local database system 10 can also transmit the semantic network representation 58 to and receive semantic network representations from other database systems with which the local database system 10 is participating in an information exchange. In one embodiment, the HL7 protocol is used to communicate the semantic network representations 58, 58′.

From the semantic network representations 58, 58′, the concept matcher 62 identifies (step 124) semantic concept equivalencies by matching concepts between the semantic network representations (as further described below). The concept matcher 62 then records (step 128) semantic concept equivalencies, for example, in the table 64, for use during database queries and concept matching. The local database system 10 stores a table of semantic concept equivalencies for each remote database with which information may be exchanged.

One or more of the steps 112, 120, 124 and 128 can also occur in response to receiving a request from the remote database system 14 to retrieve data from the local database 28. For example, if upon receiving the request the local database system 10 determines that the local semantic network representation 58 is not current, the network constructor 54 reconstructs the representation 58 (step 112) and the concept matcher 62 identifies semantic concept equivalencies (step 124) and records the equivalencies in a table (step 128). As another example, if upon receiving the request the local database system 10 determines that the remote semantic network representation 58′ is not current (e.g., because it receives a new representation 58′ with the request), the concept matcher 62 identifies semantic concept equivalencies (step 124) and records the equivalencies in a table (step 128). The semantic network representation 58′ of the remote database 28′ can be received by the local database system 28 before or with this request.

During the information exchange stage 108, the user of the client 30 who is interested in incorporating information from both the local 28 and remote 28′ databases initiates (step 132) a query. The query results in a search of the local database 28 and of the remote database 28′. Before the remote database is queried, the process 100 checks (step 136) to see if either semantic network representation 58 or 58′ has changed since the last query. For this purpose, flags or time stamps can be used to indicate whether the concept matcher 62 has the current network representations 58 and 58′.

If either representation 58, 58′ has changed, the process 100 performs steps 124 and 128 to identify and record semantic concept equivalencies. Consequently, the process 100 of the present invention accommodates dynamic changes to the databases 28, 28′; that is, a participating database system, i.e., a database system configured to exchange information with other database systems using the present invention, can be modified freely, without resulting in additional work or overhead for performing an eventual data exchange. Also, adding a new database to the data exchange group, i.e., the set of database systems that can exchange information with other database systems using the present invention, simply entails generating a semantic network representation for the new database, which then enables other database systems to exchange information with the new database.

When the table 64 of semantic concept equivalencies contains current information, the query processor 66 generates a request (step 140), in response to this query, which is then used to obtain information from the remote database 28′. To produce this request, the query processor 66 of the local database system 10 finds the semantic equivalent of the data element(s) that are to be retrieved in the table 64, for example, and issues the request to the remote database system 14 using this semantic equivalent. This semantic equivalent corresponds to a node in the remote semantic network representation 58′. As described above, the query processor 66 can transmit (step 116) the semantic network representation 58 of the local database 28 at this time. The HL7 protocol can be used to communicate the request. Also in response to this query, the query processor 66 accesses the local database 28 to obtain the same type of information requested from the remote database 28′.

The request for these semantically equivalent data elements passes to the query processor 66′ of the remote database system 14, which controls the retrieval of information from the remote database 28′. In response to the request, the query processor 66 receives (step 144) the information retrieved from the remote database system 14 over the network 18. The local database system 10 can then display the information retrieved from the remote database 28′ with results obtained by the local query of the local database system 28. In this manner, data retrieved from the remote database 28′ is incorporated at the local database system 10 with data retrieved from the local database 28. Again, for medical databases, the HL7 protocol can serve to communicate the retrieved data between the database systems 10, 14.

For example, if a user of the local database system 10 wants to retrieve “Thyroid Function Tests” from the remote database system 14, the query processor 66 identifies the equivalent concept “Endocrine Panel, Thyroid” from the semantic concept equivalency table 64 and requests this information (i.e., Endocrine Panel, Thyroid) from the remote database system 14. The query processor 66′ of the remote database system 14 then communicates with the remote database 28′ to retrieve and transmit the requested information back to the local database system 10.

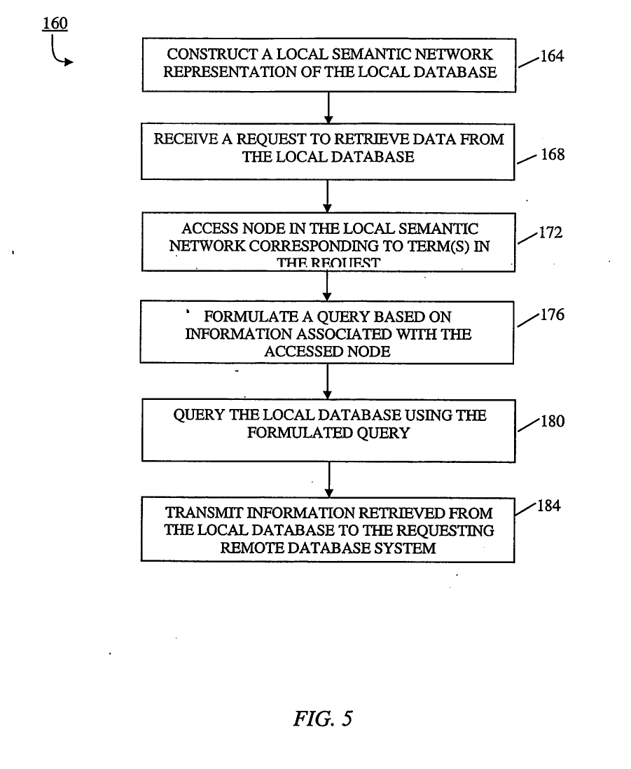

FIG. 5 shows an embodiment of a process 160 for exchanging information between the local database system 10 and the remote database system 14. As described herein, the exchange of information is from the perspective of the local database system 10, with the transfer of database information passing from the local database system 10 to the remote database system 14 and data integration occurring at the remote database system 14.

At step 164, the network constructor 54 generates the semantic network representation 58 of the local database 28. The query processor 66 receives (step 168) a request from the query processor 66′ of the remote database system 14 to retrieve information from the local database 28. The request includes one or more terms corresponding to a node in the local semantic network representation 58. The query processor 66 accesses (step 172) this node in the local semantic network representation 58 and uses information contained in the node, described further below, to construct (step 176) a query for retrieving information from the local database 28. The query processor 66 issues (step 180) the query using commands recognized by the local database 28, retrieves the database information in response to the query, and transmits (step 184) the information to the query processor 66′ over the network 18. The remote database system 14 can then integrate this retrieved information with information retrieved from the remote database 28′.

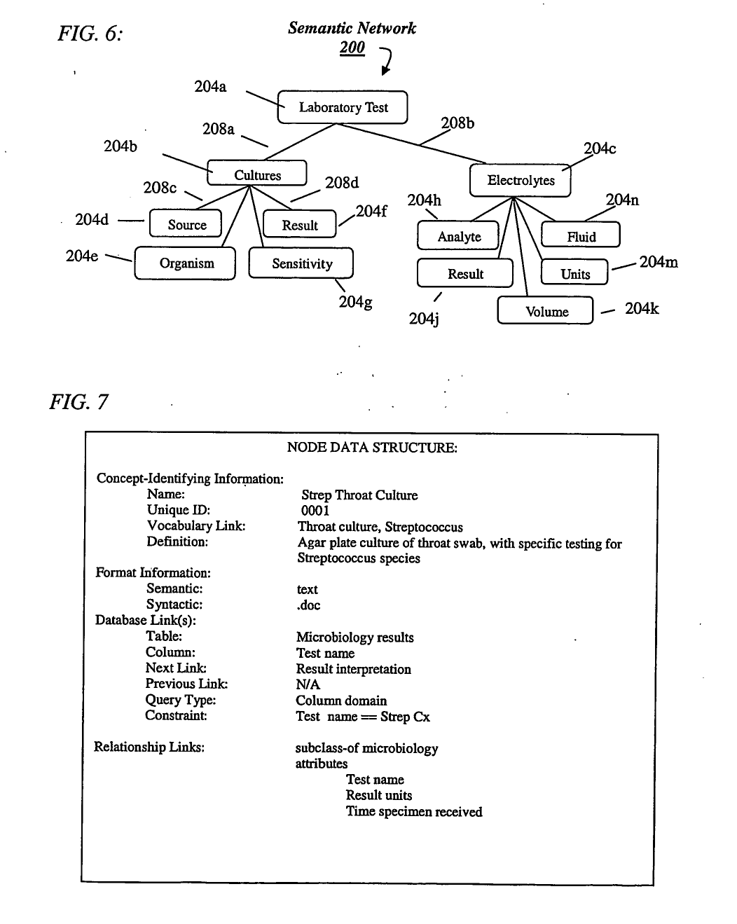

FIG. 6 shows an oversimplified example of a semantic network 200 produced by the network constructor 54. The semantic network 200 comprises nodes 204a, 204b, 204c, 204d, 204e, 204f, 204g, 204h, 204k, 204m, and 204n (generally, node 204) and links 208a, 208b, 208c, and 204d (generally, link 208). To simplify the illustration, FIG. 6 has reference numerals for only some of the links 208. The nodes 204 represent concepts (e.g., medical concepts), and the links 208 represent defined relationships between those concepts. The semantic network 200 is a directed acyclic graph, which facilitates concept matching, described in more detail below. Typically, the semantic network 200 resembles a tree because of the hierarchical property of many of the links 208. The terminal nodes 204d, 204e, 204f, 204g, 204h, 204j, 204k, 204m, and 204n, or “leaves”, of the semantic network 200, often correlate with atomic data elements within the local database 28.

In general, the semantic network 200 presents a conceptual view of a database, which includes “higher-level” concepts and atomic data elements. In a medical laboratory database, for example, the concepts can denote the normal organization of laboratory test types, e.g., hematology, microbiology, pathology, chemistry, etc. These higher-level concepts can be encoded as data elements within the represented database. Along with the information represented by the relationship links 208, the “meta-data” contained by these higher-level concepts and the network topology enable the database system of the invention to perform computations that determine semantic equivalence between concepts.

The conceptual view provided by the semantic network 200 also includes the “context” of a concept. Those nodes 204 linked to a given node (i.e., concept) by a relationship link 208 are related to that concept, and are thus referred to as neighboring nodes. Nodes 204 that are more than one link distance away from the concept are also related in a direct way (if the relationship links support transitive closure, described below) or in an indirect way. The strength of the relationship declines as a function of the link distance from the concept. Accordingly, neighboring nodes provide a semantic context grounded in the relationship links 208 and in the nodes 204 themselves. This context contains information that facilitates the semantic interpretation of a given node.

As described above, each node 204 in the semantic network 200 represents a single concept and includes information associated with that concept, including relationships to other concepts. The data structure of each node 204 accomplishes multiple purposes, including: semantic identification, facilitation of data interpretation, and linkage of the concept with the underlying local database 28. Each node 204 includes data structures that specify 1) concept-identifying information, 2) data formats, 3) database links (or “hooks”) to the local database 28, and 4) relationship links. FIG. 7 illustrates an example of the data structure of an exemplary node, named “Strep Throat Culture”.

Concept-Identifying Information

Each node 204 has concept-identifying information that uniquely classifies that node. The identifier of a particular node is unique to the database system that the node represents; it is not a universal identifier that carries across database systems. The identification information includes the following:
1) a name, which is a human readable label that corresponds to the associated concept;
2) a unique identifier for the node (which may be randomly generated), that is not reused;
3) optionally, a link to a standardized vocabulary to associate the node with semantic information; and
4) optionally, a plain-text “definition” of the concept embodied within the node. The definition is another technique for directly representing semantic information about the concept associated with the node.

Accordingly, semantic identification of the node concept is represented in a plurality of different ways. The “node name” and “node definition” provide basic semantic information about the node. The node name can sometimes be less useful, because it usually reflects the native database terminology and can be somewhat cryptic. The node definition is a plain text message designed to enable an unambiguous description of the concept that is interpretable by a user.

The vocabulary link and relationship links embody other ways in which semantic identification is associated with a node (and thus with a concept). Associating the concept with a vocabulary through the vocabulary link reduces terminology-associated semantic ambiguity and associating concepts with each other by one or more relationship links provides semantic information that enables concept matching. In one embodiment, each node 204 has a vocabulary link. In other embodiments, fewer than all nodes 204 in the semantic network 200 have a vocabulary link (e.g., in one embodiment, only leaf nodes have a vocabulary link).

More specifically, the vocabulary link is used to associate the concept of the node with concepts contained in a standardized vocabulary. The link points to a list of concepts that are semantically equivalent to or compatible with the node. This list of concepts represents a non-deterministic set of possible associations. In one embodiment in which nodes represent medical concepts, the standardized vocabulary is the Unified Medical Language System (UMLS) Metathesaurus. The UMLS Metathesaurus is a collection of many independent medical vocabularies from various sources. The medical concepts catalogued through the Metathesaurus form a comprehensive subset of concepts that are in current clinical use. The collection of medical concepts from many sources allows the Metathesaurus to function as a reference point for mapping between vocabularies. Examples of other standardized vocabularies include the Logical Observation Identifiers Names and Codes (LOINC) system, which encodes laboratory test results in a standard structure that can be used to represent and communicate the contents of laboratory databases.

Data Formats

The “format” data structure facilitates data interpretation by providing semantic and syntactic information. Two format parameters, “type” and “encoding”, indicate how to interpret data retrieved from the local database 28. The semantic information is the type of information being represented (e.g., number, text, image, sound, aggregate concept, etc). The syntactic information is the encoding of the information. The encoding specifies how the information is actually stored. The encoding for the information may differ from the type. For example, a node 204 corresponding to a platelet count is interpreted semantically as type “number”, but the value representing the count may be encoded as a text string in the source medical database system. Also, a variety of encodings may be available for the same type, e.g. type: “image”, encoding: JPEG, PICT, or PDF, etc. The explicit use of encoding information allows the usage of standardized routines to display the data or allow conversion between encodings. In one embodiment, the format data structure also points to executable code that correctly displays or otherwise interprets the raw data.

Database Link

The “database link” data structure operates to bridge the semantic network representation 58 with the raw data in the local database 28. To retrieve data from a database, a database link exists between each node 204 of the semantic network 200 and an atomic data element in the local database 28. Each database link represents a call to the database system to retrieve the actual data item of interest. In one embodiment, the data structure and functionality of the database link is optimized for relational databases.

In one embodiment, each database link includes the following components:
1) Table: a database table that contains the data element of interest.
2) Column: the table column that contains the data element of interest.
3) Next link: the next database link to use when executing some forms of multi-part queries.
4) Previous link: the previous link in some forms of multi-part queries.
5) Query type: the method used to retrieve information from the database. Query types that are used for a relational database include:
   a. Column value: retrieve data by specifying the name of a column.
   b. Column domain: retrieve data by specifying a value within the column domain (i.e., the values of data elements within the column).
   c. Column pointer: the data value within the column is a pointer to another table or column.
   d. Aggregate: the data element is actually composed of lower level data elements. Therefore, the database links for the lower level data elements are to be used, possibly in a recursive fashion, to retrieve the information for the higher-level data element.
6) Attributes: which are parameters associated with the node concept that are retrieved whenever the concept data are retrieved, and that are inherited by all subclasses (i.e., specialization relationship described below) of the node 204. For example, for “Strep Throat Culture”, attributes can include the result units, a time-stamp for when the result was reported, and an order accession number. In a relational database, an attribute is most likely to be other columns within the same table. Thus, the Strep Throat Culture table would contain columns for result units, time stamp, and order accession number.
7) Constraints: a set of Boolean expressions that constrain the data values to retrieve.

Using the defined database link, the query processor 66 directly generates a query that is executed by the local database 28. Generation of the query requires procedural knowledge regarding how the local database system 10 operates, and a database driver that can be called by other applications. In one embodiment, the local database system 10 is configured to interface with relational databases, and the database links of the nodes 204 contain data structures and algorithms that specify the elements of relational tables and generate SQL queries for data retrieval. This function is customized to attain functionality and integration with other database systems that have different types of databases (e.g. hierarchical, flat file, CORBA-mediated).

Relationship Links

Each node 204 has a data structure for relationships that contains information specifying how that node relates to other nodes. An association between two nodes or concepts can include a plurality of different relationships. For example, the concept “electrolytes” can be correctly related to “blood chemistries” through the “subset-of”, “subclass-of”, and “component-of” relationships.

The relationships are directional, so each node 204 directly specifies its relationship with the target of that relationship. For example, if “time stamp” is an attribute of the node “Lab Result”, then “time stamp” contains the relationship “attribute-of” “Lab Result”, and “Lab Result” contains the relationship “has-attribute” “time stamp”.

Links 208 within the semantic network 200 represent the conceptual relationships between the concepts identified by the nodes 204. Relationship links include, but are not limited to, the following:
1. Identity: “same-as.” This relationship indicates that two concepts are synonymous. In particular, all the components of the node data structure are identical except for the name and Unique ID fields in the Identification information data structure.
2. Specialization: “subclass-of,” “superclass-of.” This relationship follows the semantics of conventional object-oriented class specialization, where subclasses inherit attributes and functionality (or “methods”) of their superclasses. Subclasses are restricted to modifications that preserve the attributes (i.e. may add more attributes) and retain the method call forms (i.e. may change the function of the method but preserve the call and parameter list, or may add a new method) of the superclass.
3. Composition: “component-of,” “composed-of.” The composition relationship indicates that the semantic content of the higher-level node (the “construct”) is built from the semantic content of the lower-level nodes (the “components”). In addition, all the components are present for the construct to be a valid entity. The components are necessary and sufficient parts to define the higher-level node, and the addition or elimination of a component creates a different construct. For example, if a “bleeding screen” is composed-of the prothrombin time (PT), the partial thromboplastin time (PTT), and a fibrinogen level, then requesting the PT and PTT without the fibrinogen level does not constitute a “bleeding screen”.
4. Aggregation: “element-of,” “collection-of.” In contrast to composition, aggregation does not require all of the lower-level nodes (the “sub-elements”) to be present in order to define the higher-level node (the “aggregate”). The semantic content of the aggregate is defined by the content of the sub-elements, whatever those sub-elements might be. This relationship enables the representation of lists with variable size (e.g., a medication list) and aggregates of data that may have variable membership (e.g., the aggregate symptoms required for the diagnosis of Rheumatic fever).
5. Set relationships: “subset-of,” “superset-of.” This relationship follows the standard mathematical definition, with set elements defined by lower-level nodes.
6. Attribution: “attribute-of,” “has-attribute.” Attributes are lower level nodes that are associated with a higher-level node (the “foundation”) through the property of inheritance. Attributes are the characteristic bits of information that are inherited by subclasses of the foundation. As illustrated in a previous example, a “Lab Result” may have attributes of “result units”, a “time stamp” for when the result was reported, and an “accession number”. These attributes are inherited by all subclasses of “Lab Result”.

To facilitate the proper retrieval of data with related properties (e.g., the “Strep Throat Culture” discussed above), the attribution relationship is included. In particular, the structure of relational databases confers a practical definition in terms of the associated (single table) columns that are retrieved during a query.

Properties of the relationship links are shown in Table 1.

TABLE 1

| Relationship | Commuta- | Transi- | Hier- | Inherit- | Depend- | Over- |
|---|---|---|---|---|---|---|
| Type | tive | tive | archy | ance | ence | lap |
| Identity | Yes | Yes | No | No | No | Yes |
| Specialization | No | Yes | Yes | Yes | No | Yes |
| Composition | No | Yes | Yes | No | Yes | No |
| Aggregation | No | Yes | Yes | No | No | No |
| Set relations | No | Yes | Yes | No | No | Yes |
| Attribution | No | Yes | Yes | No | No | No |

For a given relationship * (or its inverse), the properties have the following meanings:
1. Commutative: a*b implies b*a.
2. Transitive: a*b and b*c implies a*c.
3. Hierarchy: a*b implies a is a “higher-level” class and b is a “lower level” class. Hierarchy has transitive closure.
4. Inheritance: a*b implies b inherits attributes from a.
5. Dependence: a*b implies the semantic meaning of a is dependent upon b.
6. Overlap: a*b implies there are overlapping properties or elements between a and b.

The inferences that are supported by the relationship links depend not only upon the semantics of the relationship, but also upon some of the basic properties of the relationship (as outlined previously in Table 1). Two such inferences are generalization and decomposition. Generalization, as used herein, involves traversal of the relationship links (e.g., the “subclass-of”, “component-of”, “element-of”, and “subset-of” relationships) up the hierarchy of the semantic network. The concept matching algorithms described below utilize one or more of such hierarchical relationships when generalizing a concept for matching. Decomposition of a concept involves determining the various subcomponents that make up that concept. Accordingly, the concept matching algorithms use one or more of the hierarchical relationships (e.g. “composed-of”, “collection-of”, and “superclass-of”) to descend the semantic network hierarchy when decomposing a concept.

The transitive closure, for example, supports unidirectional traversal across the semantic network using the pertinent relationship. Accordingly, transitive closure and hierarchy are properties that support the inferences of generalization and decomposition. Other inferences are possible based upon other properties, for example, the transitive closure and hierarchy properties are useful for generating a list of concepts that are examined for a change in their semantics when a concept is deleted from the database system.

Semantic Network Construction

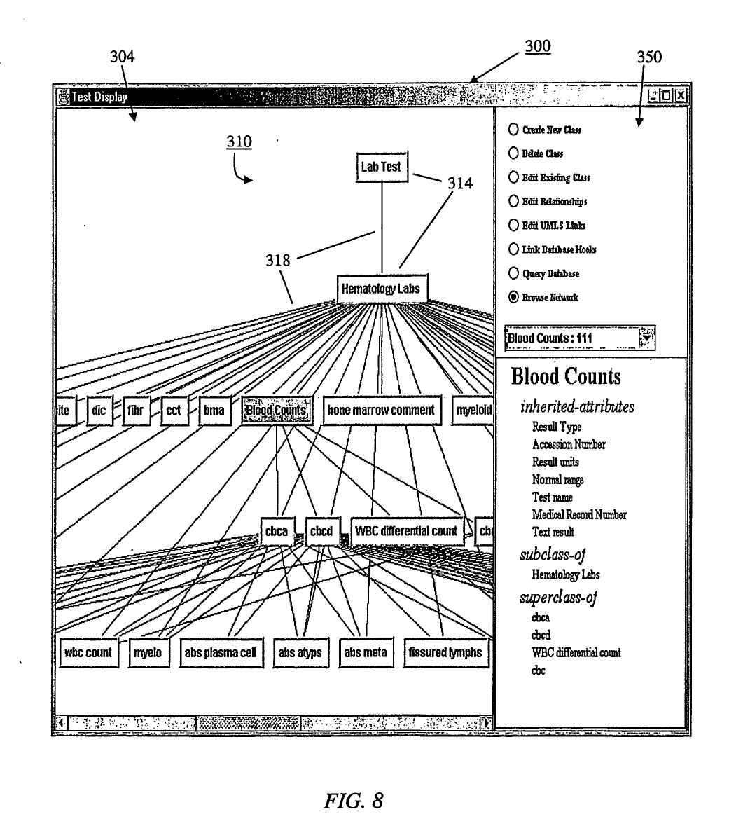

Construction of the semantic network occurs without regard to the nature or number of other databases with which information exchange may occur. Modifications to the semantic network reflect changes in the local database only, and do not reflect changes in remote databases. To facilitate the construction of a semantic network, a user of the client 30 (FIG. 1) manipulates a graphical user interface produced by executing software of the present invention. FIG. 8 shows a screen shot 300 of main interface window. An embodiment of a semantic network 310 is shown graphically in a sub-window 304 that allows navigation through a point-and-click interface. The screen shot 300 also includes an “activity” sub-window 350, in which the “browse network” activity is selected. This graphical user interface enables users to visualize nodes 314 and relationship links 318 as they are generated or modified. The functionality for constructing the semantic network 310 is supported within the graphical user interface, including node creation, modification, and deletion.

Data elements within the local database 28 are each represented by a node 314 that uses the data element “name” for the node name. When the data element names are cryptic, an expanded node name using basic medical terminology is desirable but not always possible if the original data naming convention is too obscure to interpret. The unique ID of each node 314 is assigned in a manner that ensures non-duplication of the field within the semantic network 310. Implementing a unique ID field allows the reuse of node names if the underlying data element changes but the semantics of the concept remain the same.

In one embodiment, external programs read information from the local database 28 and convert that information to nodes 314 and relationship links 318, thus facilitating the construction of the semantic network 310. This approach initially populates the network 310, with further refinement being performed by utilizing the graphical user interface. In general, the design and finalization of the relationship links 318 are performed through the graphical user interface because the relationship semantics are seldom directly extractable from the local database 28.

After each node 314 is generated, that node 314 is linked to zero or more other existing nodes using the predefined relationships links described above. To accomplish this task, the user highlights the node 314 in the graphical user interface and selects the “edit relationships” activity in the activity sub-window 350. These generated relationships are then displayed within the graphical user interface as network links 318 between the participating nodes.

Users can choose as many relationships between pairs of nodes 314 as applicable, although instantiating all possible relationships is somewhat redundant, even if it is technically correct. These relationship overlaps produce a form of semantic variability in which multiple “correct” semantic network configurations are possible for the same set of concepts. Because of this uncertainty, some matching algorithms use all available hierarchical relationships to traverse the semantic network during concept generalization and decomposition.

Each node 314 may be linked to a list of concepts provided by a standardized vocabulary (e.g., UMLS Metathesaurus). The standardized vocabulary embodied in the UMLS Metathesaurus, for example, provides support for concept matching, described below.

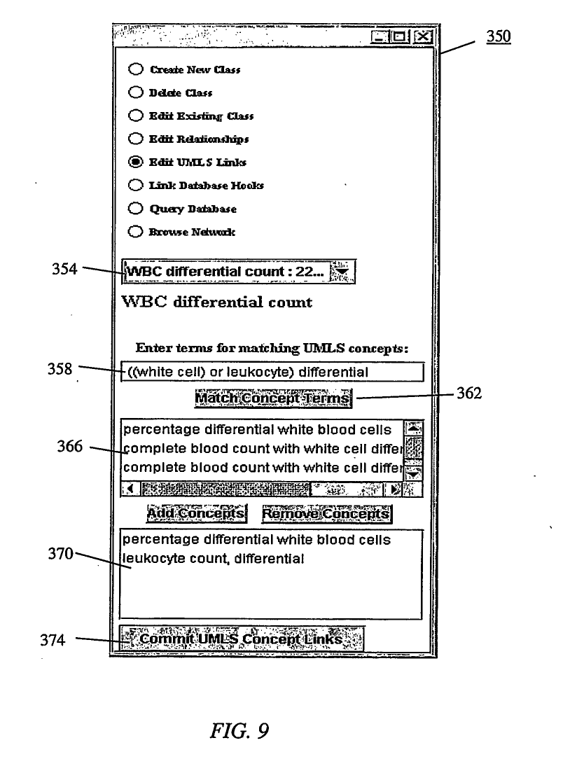

FIG. 9 shows the graphical user interface “activity” sub-window 350 of FIG. 8, in which the “edit UMLS links” activity is selected for accomplishing the task of defining a vocabulary link for a node 314 identified in the field 354. To create the vocabulary link, the user uses the graphical user interface to specify a concept phrase or list of terms that are semantically equivalent to the node 314. The user enters the list of terms into the designated field 358 in the window 350. In one embodiment, a parser allows the search terms to be entered as a Boolean expression. Another embodiment includes an automatic plural form generator that produces the plural forms of match terms using standard rules of English. For example, when the match term “cell” is entered, the plural form “cells” is automatically generated, and when “fungus” is entered, “fungi” is automatically generated.

Upon pressing the graphical button 362, a matching algorithm is then used to retrieve locally stored concepts (i.e., from the thesaurus). Several features are implemented within the matching algorithm to optimize the presentation of candidate concepts. Concepts that contain matching terms are assessed using a metric that takes into account the number of matched node terms as well as the position of those terms within the concept phrase. Concepts with the highest score are placed at the top of the candidate list so that the user is presented with the most likely matches first. The matched concepts appear within the sub-window 366, from which the user chooses zero or more equivalent concepts.

The selected concepts appear in the sub-window 370, and the user presses the graphical button 374 to confirm the vocabulary for the identified node 314. The concepts are then placed in the vocabulary link of the node 314. Because individual users may differ in their judgment of “semantically equivalent” terms, the link is not a precise or rigorous parameter. Instead, the vocabulary link functions as a “possibility set” of semantic states that the node 314 can attain.

Concept Matching

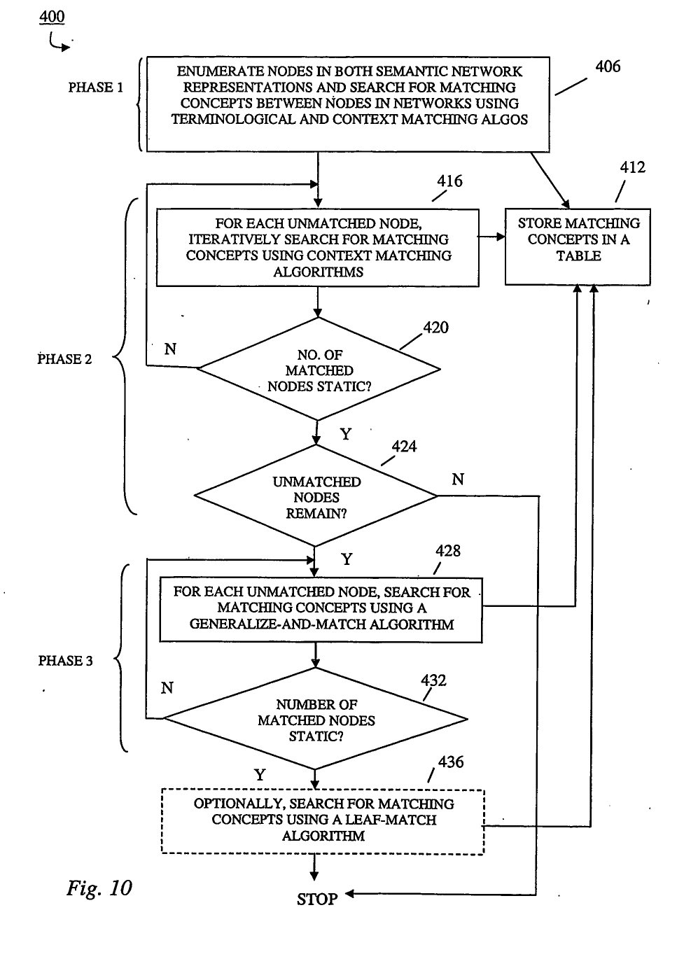

FIG. 10 shows an embodiment of a process 400 for matching nodes (or concepts) between the semantic network representations 58, 58′ of the local and remote databases 28, 28′. Concept matching occurs when data is communicated if the semantic network representation 58, 58′ of either participating database 28, 28′ changes. In general, concept matching is achieved using any one or combination of the matching algorithms described below. Other types of matching algorithms can be used in addition to or instead of these described algorithms without departing from the principles of the invention.

In one embodiment, the concept matching of the invention can be considered as having three phases. During a first phase, the nodes of each of the two input semantic network representations are enumerated (step 406). Matches between the nodes of the semantic network representations are searched for using a terminological match algorithm, sub-component context match algorithms, nearest neighbor context match algorithms, and a sibling context match algorithm. Enumerating involves comparing each node (i.e., target node) in the local semantic network representation 58 with each node in the remote semantic network representation 58′ to find a match. Multiple matches for each target node can be identified. Identified concept matches are stored (step 412) in the table 64 (FIG. 1), e.g., a hash table, for later referral. In practice, the terminological matching algorithm finds most of the matches identified during the first phase; the context matching algorithms rely on previously identified matches and their effectiveness increases as more matches are found and stored in the table 64. Thus the table of stored matching nodes improves the efficiency of those matching algorithms that rely on finding similarities between concept contexts, since multiple neighboring nodes may also need to be matched.

During a second phase, an iterative matching process is performed (step 416) for the unmatched nodes of the first phase. To match a target node, one or more of the context matching algorithms are used to look for matches between neighboring nodes of the target node and nodes of the remote semantic network. Identified concept matches are also stored (step 412) in the table 64 (FIG. 1), enabling each subsequent iteration to possibly identify one or more new matches. The iterations in the second phase continue (step 420) until the total number of matched nodes remains static (unchanged for consecutive iterations).

During a third phase, if at step 424 there are still unmatched nodes, a “generalize-and-match” process is performed (step 428) on the unmatched nodes remaining from the second phase. The generalize-and-match process generalizes a node by finding the “superclass” of that node using the “subclass-of” relationship links within the semantic network representation. If the “subclass-of” relationship does not exist for the pertinent node, the “subset-of,” “component-of,” and “element-of” hierarchical relationships are tested successively until a higher-level class is found. To match the higher-level superclass, if possible, the generalize-and-match process uses matches already in the table 64. Concepts matched by the generalize-and-match process are stored (step 412) in the table 64. The generalize-and-match process is recursively iterated until the superclass is matched or no superclass is found (i.e., the search for a matching superclass iteratively moves up a level of the local semantic network hierarchy).

A node is matched if at least one of the six algorithms or the generalize-and-match process returns a matching node from the remote semantic network during any one of the three phases. Optionally, a seventh matching algorithm, referred to as a leaf-match algorithm, is used (step 436) after execution of the automated concept matching process (i.e., the six previous algorithms and generalize-and-match process). Leaf-node concept matches are stored (step 412) in the table 64.

The matching algorithms can be categorized as follows:
1. Terminological match. This algorithm matches concepts using links to the standardized vocabulary.
2. Context match. These five algorithms (described below) match concepts by examining the context (i.e., network neighborhood) of the target node. Various combinations of neighboring nodes are examined, including the sub-hierarchy context, sibling context, and general nearest neighbors. The various contexts are matched in the remote semantic network, using various search algorithms to identify the best match for the target node. Context match algorithms include:
   a) Subcomponent context. Use the context represented by subcomponents (leaves) of the target node.
   b) Nearest neighbors context. Use the context represented by the neighbors of the target node (i.e., one link away from the target node).
   c) Sibling context. Use the context represented by sibling nodes (i.e., sibling have the same parent node).
3. Leaf match. This seventh algorithm matches as many of the subcomponents (i.e., leaves) as possible.
   Terminological Match Algorithm

The terminological match algorithm uses the vocabulary links to find matching nodes. Nodes from the two semantic networks match if they have one or more common elements in their vocabulary links. Due to the indeterminate content of the links, there is no guarantee that matches can be found, or that matches are unique. The local “neighborhood” of the target node is not considered in this algorithm. Pseudo-code for the terminological matching algorithm (using UMLS as the vocabulary link) is as follows:

For each target-node in the local semantic network

target-UMLS-list <= UMLS list of target-node
For each remote-node in the remote network

remote-UMLS-list <= UMLS list of remote-node
For each target-item in the target-UMLS-list

For each remote-item in the remote-UMLS-list

If (target-item equals remote-item) then

Add remote-node to matching-nodes

Return matching-nodes

Sub-Component Context Match Algorithms

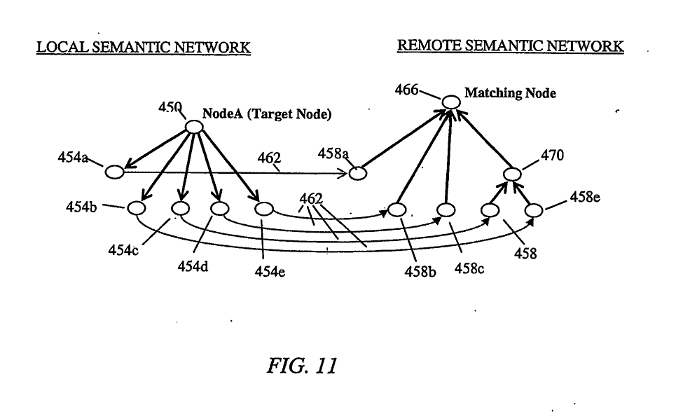

FIG. 11 illustrates the operation of the sub-component context match algorithm, which finds the “lowest common superclass.” To match a given target node 450 in the local semantic network (here, node “NodeA”), the algorithm finds any leaf nodes 454a, 454b, 454c, 454d, and 454e (generally, leaf node 454) that are in sub-hierarchy of the target node 450. These leaf nodes 454 are then matched to nodes 458a, 458b, 458c, 458d, and 458e (generally, matching nodes 458) in the remote semantic network (each pair of matching nodes is indicated by a connecting arrow 462 from a leaf node 454 of the local semantic network to a corresponding matching node 458 in the remote semantic network).

Within the remote semantic network, a search process is started from each of the matching nodes 458. The search proceeds in a breadth-first (BFS) fashion “up” the network hierarchy from each of the remote matching nodes. To limit the amount of searching performed, a limit on search distance can be imposed on the BFS. Changing this limit affects the number of nodes searched and consequently the number of nodes that are considered as potential matches for the target node. In one embodiment, the BFS is limited by ensuring that the search does not exceed the depth of the remote semantic network or the number of nodes in the remote semantic network. The BPS terminates if nodes found during the search have already been visited or if the limit of the search is reached.

The “lowest common superclass” is the lowest node in the hierarchy of the remote semantic network with the greatest number of search “hits” resulting from the searches that originate from each of the remote matching nodes. In the example shown, matching node 466 is the lowest common superclass, having five search hits (in FIG. 11, one for each BFS performed from each remote matching node), which is greater than the two search hits received by the node 470. Pseudo-code for the sub-component context matching algorithm is as follows:

For each leaf-node of the target-node

Retrieve remote-matching-node from matching hash table
While termination condition is false
For each remote-matching-node in the remote network

Perform BFS up the remote network hierarchy
Mark each node traversed with a unique “hit” label

Count hits for each node traversed
If ((maximum hit count remains static) or (no more nodes to

Search)) then Terminate condition for While loop is true

Return remote node with maximum hit count

A variation of the sub-component context matching algorithm excludes specialization links from any network traversal operation (e.g., when finding leaf nodes or during BFS) to narrow the search space and reduce the amount of searching. Specialization links contain hierarchical information about the semantic network, but are much less constraining than the other hierarchical relationships.

Accordingly, this sub-component context matching algorithm and its variation are complementary. The sub-component context matching algorithm uses the broadest search space available, which is useful when the semantic network is sparse. By narrowing the search space, the algorithm variation returns more accurate results when the semantic network is denser.

Nearest Neighbor Context Match Algorithms

The nearest neighbor context match algorithm performs a BFS within the local semantic network to find the nodes closest to the target node “NodeA”. These neighboring nodes are then matched in the remote semantic network. A BFS is then performed from each remote matching node. The remote network node(s) with the greatest number of hits from the BFS are returned as the best match for target node NodeA. Pseudo-code for the nearest neighbor context match algorithm is as follows:

Local-neighbors <= perform BFS for 1 link distance from target node
Remote-neighbors <= retrieve match for each Local-neighbor from

matching hash table

While termination condition is false

For each Remote-neighbor

Perform BFS in remote network
Mark each node traversed with a unique “hit” label

Count hits for each node traversed
If ((maximum hit count remains static) or (no more nodes to
Search))

Then {Terminate condition for While loop is true}}

Return remote node with maximum hit count

A variation of this algorithm performs the nearest neighbor context match algorithm, matches the neighboring nodes (from the BFS) in the local semantic network with nodes in the remote semantic network, and excludes these remote matching nodes from the result.

Sibling Context Match Algorithm

The sibling context match algorithm matches the parent node and “sibling” nodes in the remote network and then excludes these nodes as candidate matches. For example, consider a parent node NodeA and children nodes NodeB, NodeC, and NodeD. When attempting to match target node NodeB, the parent NodeA is found and matched in the remote semantic network to find NodeARemote. The children nodes of NodeARemote are then found. Sibling nodes of nodeB, nodes NodeC and NodeD, are then matched in the remote semantic network, and the matching nodes NodeCRemote and NodeDRemote are excluded from consideration by eliminating them from the set of children nodes of NodeARemote. The remaining children of NodeARemote are returned as candidate matches for NodeB.

After the three phases of the concept matching process are performed, the user can choose to execute an additional matching algorithm, for example, if the previous match results are unsatisfactory. For nodes that have subcomponents, the user may execute a leaf-match algorithm to match the leaves of the sub-hierarchy instead of matching the target node itself.

Leaf-Match Algorithm

The leaf-match algorithm is performed on all “non-leaf” nodes (i.e., nodes that have leaves) in the local semantic network. Leaf matching provides a complementary pathway for data retrieval by utilizing the decomposition and equivalence inferences. The leaf-match algorithm does not attempt to find the semantic equivalent of the target node, but instead tries to match all the data elements that make up the sub-hierarchy of the target node by decomposing an aggregate node into its constituent concepts and finding the equivalents for those concepts. Accordingly, the leaf match retrieves information that is different from that retrieved by the other concept matching algorithms. In some circumstances, this may be preferable to using the semantically equivalent match to retrieve information from the remote database. For example, if the sub-hierarchy for the target node in the local semantic network is larger than the equivalent sub-hierarchy in the remote semantic network, more information may be retrieved using the leaf-match algorithm than by using the semantically equivalent match to the target node.

Modifying the inference processes for leaf matching can produce different results. For example, modifying the decomposition process to stop after one level of decomposition (rather than continuing until the leaves of the local semantic network are reached), the leaf match becomes a “decomposition match” that may retrieve different information from the remote database.

Limiting the Number of Matches Using Thresholds

Because of the large “fan-out” of linkages between some concepts and their subcomponents, the search patterns of the matching algorithms can return multiple leaf nodes that are not distinguishable from each other based on contextual information. In this instance, specious results produced by one of the matching algorithms can overwhelm more reasonable results produced by a different algorithm. In one embodiment, a threshold (e.g., three matches) is imposed on each matching algorithm to limit the number of candidate matches that each algorithm is permitted to produce. If the number exceeds the threshold, all the candidate matches from that algorithm are discarded as probable noise.

Match-Quality Metric

After the concept matching process is completed, the user can assess the quality of the node matches to evaluate the efficacy of the matching process. Each matching node is displayed with an associated “match quality” metric. The match-quality metric measures the set “coverage” or overlap between two concepts. For a leaf match, a quality score measures the set coverage for the target concept. The quality score represents the “amount” of information that is available for that target concept.

If multiple matching remote nodes are found for a given local node, the match-quality metric serves as a guide to the user for choosing the best match from the candidate matches, or for automating the choice of matches. Several parameters are used within the quality metric to capture different aspects of the match. These parameters include:
1) Overall quality: A match between two nodes is called a “perfect” match if all subcomponents of both nodes also match. Otherwise, the match is a “partial” match.
2) Coverage. A match has “full set coverage” with respect to the local target node if all the subcomponents of the local target node are matched and contained in the subcomponents of the remote node. Otherwise the match has “partial set coverage”.
3) Score. The score is calculated by taking the number of matching subcomponents (intersection between the subcomponents) divided by the total number of unique subcomponents (union of the subcomponents), multiplied by 100. This produces a range from 0 to 100. Using the subcomponent context (nodes in the sub-hierarchies) is a more specific measure of concept similarity than using the more general context, which includes all neighboring nodes.

If more than one candidate matching node is found in the remote semantic network, the system can calculate a “best match” based on the highest quality score. When two or more candidate matches have the same quality score, the node with, the smallest sub-hierarchy is returned as the most “specific” node (i.e. least generalized).

Match Types

Match types are differentiated by the method used to establish the match. The differentiation is used because different network traversal routines and variations of the quality metric are used for the different match types. From the concept matching process described previously, the match types are:
1) Direct match. The match is made during the first two phases of the concept matching process.
2) Generalized match. The match is made during the “generalize and match” phase of the concept matching process because the target node was previously unmatched.
3) Leaf match. The user manually directs the system to perform a leaf match.
4) Validated match. During review of the concept matches, the user manually confirms that a match is semantically equivalent and should be used for all future data integration purposes. A validated match is preferentially used regardless of the quality metric.

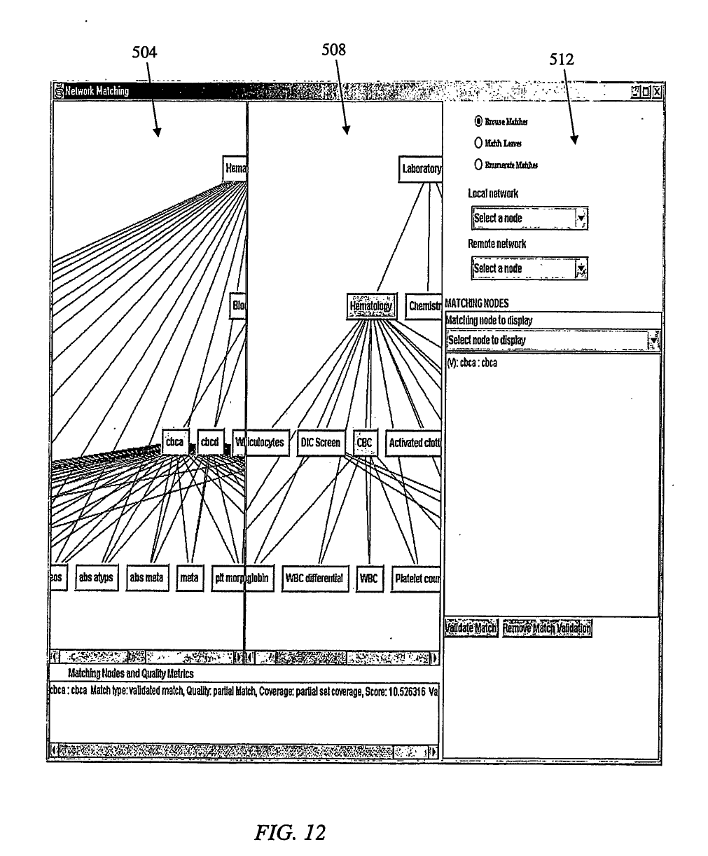

To assist the user in evaluating the semantic concept matches, a graphical user interface displays the semantic network environments within which the concept matches are made. FIG. 12 shows an example of the graphical user interface, which displays the local and remote semantic networks in first and second sub-windows, 504, 508, respectively, and user-selected node matches in a third sub-window 512. The quality metric for each node match is also displayed. This allows the user to judge the suitability of the automated matches and decide which matches to validate.

Database Linkages

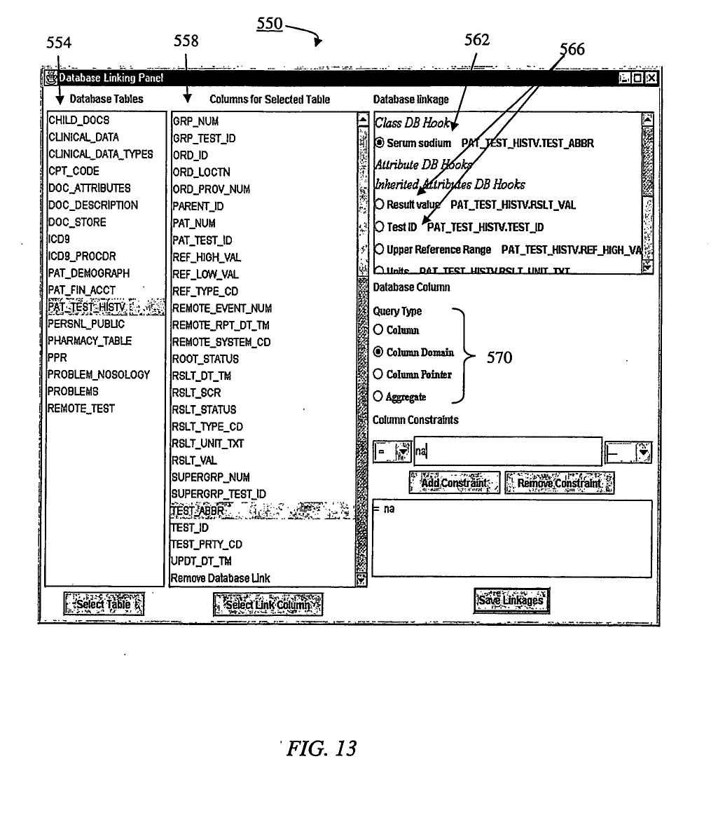

FIG. 13 shows another example of a window 550 presented in a graphical user interface, which enables the user to form the linkage between nodes in the local semantic network and database elements within the local database. In the embodiment shown, the local database is a relational database. The user selects the table 554 and column 558 to link with each element of the database link, including the main concept 562 (serum sodium in this example) and attributes 566 (e.g. Result value, Test ID, etc.)

In one embodiment, the database link is associated with one of four different types of queries (reference numeral 570 in FIG. 13). Delineating the query type enables the process of retrieving data elements from the local database. These query types include:
1) Column value. This query type indicates that the information content for the node is directly contained within the table column. For example, the node for “serum sodium” has its primary link to the column “serum sodium” within the table “serum electrolyte values”.
2) Column domain. This is the query type selected in FIG. 13, where the main concept is in the domain of the column, i.e., one of the possible values of the column. In general, the column contains a label that is equivalent to the node identity and the actual data elements are contained within other columns.
3) Column pointer. The column does not contain data directly related with the main concept, but instead contains a pointer to another column, possibly in a different table.
4) Aggregate. As discussed previously, this storage type indicates that the node is not directly linked to the database, but derives its information from nodes within its sub-hierarchy.

Database links also contain information linking attributes of the node to their respective data elements. In many relational databases, all the data elements for a node are contained within one table.

After the semantic concept equivalencies between networks have been identified through the matching process, queries are executed by retrieving the matching nodes from the remote semantic network. To retrieve a thyroid function panel, for example, the system identifies the semantically equivalent concept in the remote semantic network by looking up the node match. The information contained in the remote node's database link is then used to retrieve the data directly from the remote database 28′.

Query Processing

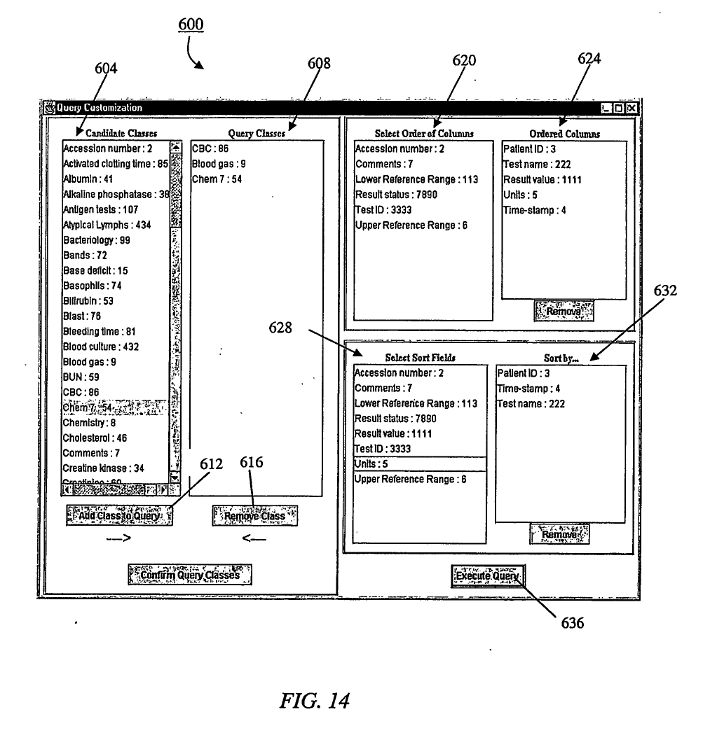

To facilitate the retrieval and formatting of data, a graphical user interface presents a window 600, shown in FIG. 14, for formulating and sorting query results. A first sub-window 604 displays available query classes. The local database system 10 automatically, or the user manually, selects the query classes. The selected query classes appear in the sub-window 608. The user can add to or delete from the list of selected query classes using the graphical add and remove buttons 612, 616. The column arrangement of data presentation and sort order can also be specified in sub-windows 620, 624, 628, and 632. After the query classes are selected (and confirmed) and the sort order and column arrangement are specified, the user can execute the query by pressing the designated graphical button 636. In one embodiment, the user also selects the type of retrieval process (e.g., leaf-match or concept-match retrievals, described below).

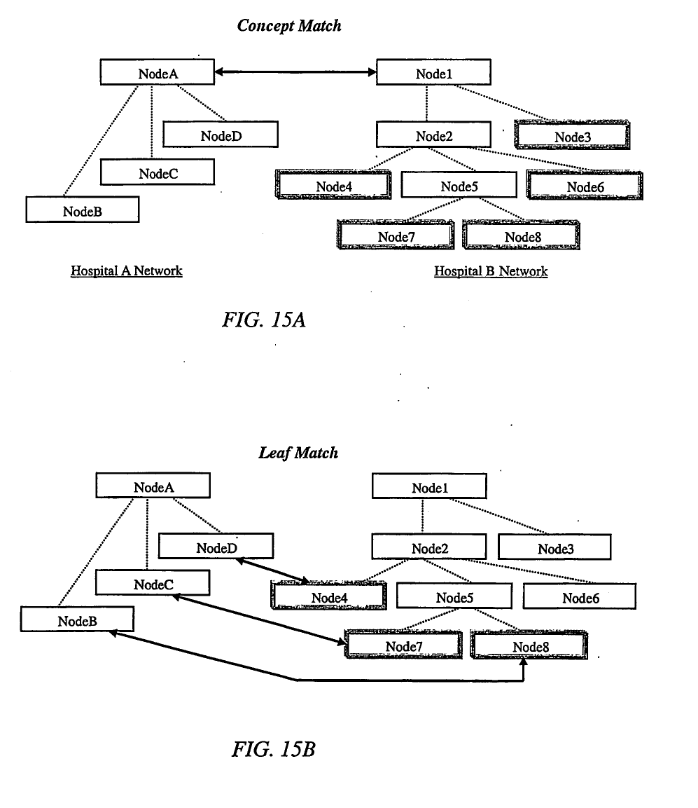

The particular data elements retrieved from the remote database 28′ depend upon the type of retrieval process used. FIG. 15A and FIG. 15B illustrate two different types of retrieval processes for retrieving information from the remote database 28′. A first type of retrieval process, shown in FIG. 15A and referred to as a concept-match retrieval, retrieves the matching nodes from the remote database 28′. For example, if the node “nodeA” in the local database of Hospital A is matched with node “node1” in Hospital B (as denoted by double arrows), when Hospital A's local database system issues a query for the node “nodeA”, Hospital B's database returns five data elements for “node1” in response to the query. These returned data elements (highlighted in bold) are leaf nodes “node3”, “node4”, “node6”, “node7”, and “node8”.

The second type of retrieval process, shown in FIG. 15B and referred to as a leaf-match retrieval, retrieves the matching leaf sub-nodes from the remote database 28′. Using the same example shown in FIG. 15A, if the node “nodeA” has leaf sub-nodes “nodeB”, “nodeC”, and “nodeD”, which, as denoted by double arrows, match nodes “node4”, “node7”, and “node8”, respectively, in Hospital B's remote database, then a query for node “nodeA” retrieves leaf nodes “node4”, “node7”, and “node8” (highlighted in bold), and not “node1”.

While the invention has been shown and described with reference to specific preferred embodiments, it should be understood by those skilled in the art that various changes in form and detail may be made therein without departing from the spirit and scope of the invention as defined by the following claims. For example, the present invention can be implemented in hardware, software, or a combination of hardware and software. Also, the components of local database system 10 of the present invention can reside in a single computerized workstation or be distributed among several interconnected computer systems (e.g., a network).

1. A system for exchanging information between a first database and a second database, the system comprising:
a constructor for producing a first semantic network representation of the first database;
a concept matcher for identifying semantic concept equivalencies between the semantic network representation of the first database and a semantic network representation of the second database; and
a query processor using one of the identified semantic concept equivalencies to generate a request to access data from the second database.

2. The system of claim 1, wherein the semantic network representation of the database includes a plurality of nodes, each node representing a concept, at least one of the nodes having a link to the first database for use in formulating a query.

3. The system of claim 2, wherein each node represents a medical concept.

4. The system of claim 1, wherein the semantic network representation of the database includes a plurality of nodes, each node representing a concept, at least one of the nodes having a link to a vocabulary.

5. The system of claim 4, wherein the vocabulary is the Unified Medical Language System Metathesaurus.

6. The system of claim 1, wherein the semantic network representation of the database includes a plurality of nodes, each node representing a concept, at least one node having a first link to the first database for use in formulating a query and a second link to a vocabulary.

7. The system of claim 6, wherein the at least one node has a definition associated therewith.

8. The system of claim 1, further comprising a table storing the semantic concept equivalencies.

9. The system of claim 1, further comprising a transmitter for sending the request generated by the query processor over a network to a database system comprising the second database.

10. The system of claim 9, wherein the transmitter sends the first semantic network representation to the database system comprising the second database.

11. The system of claim 1, wherein the query processor uses the first semantic network representation to formulate a query that accesses data in the first database in response to a request received over a network.

12. The system of claim 1, further comprising a receiver for receiving the second semantic network representation over a network from a database system comprising the second database.

13. The system of claim 1, further comprising a receiver for receiving data over a network transmitted from a database system comprising the second database in response to the request.

14. The system of claim 1, wherein the network constructor allows reconstruction of the first semantic network representation if the first database changes.

15. The system of claim 1, wherein the concept matcher establishes a context for at least one node in the first semantic network representation and identifies a matching concept in the second semantic network representation for the at least one node using the established context.

16. The system of claim 1, wherein the concept matcher dynamically re-identifies semantic concept equivalencies between the semantic network representation of the first database and the semantic network representation of the second database if one of the semantic network representations changes.

17. A method for exchanging data between databases, the method comprising:
generating a first semantic network representation of a first database;
receiving a second semantic network representation of a second database;
identifying semantic concept equivalencies between the first and second semantic network representations; and
producing a request to retrieve information from the second database using at least one of the identified semantic concept equivalencies.

18. The method of claim 17, further comprising linking at least one node in the first semantic network representation to a vocabulary list.

19. The method of claim 18, wherein identifying semantic concept equivalencies includes comparing each term in the vocabulary list linked to the at least one node in the first semantic network representation with each term in a vocabulary list linked to at least one node in the second semantic network representation.

20. The method of claim 17, wherein identifying semantic concept equivalencies includes establishing a context for at least one node in the first semantic network representation, and identifying a matching concept in the second semantic network representation for the at least one node using the established context.

21. The method of claim 20, wherein the context includes at least one sibling node of the at least one node in the first semantic network representation.

22. The method of claim 20, wherein the context includes at least one neighboring node of the at least one node in the first semantic network representation.

23. The method of claim 20, wherein the context includes at least one leaf node depending from the at least one node in the first semantic network representation.

24. The method of claim 17, wherein identifying semantic concept equivalencies includes matching a concept represented by at least one node in the first semantic network representation with at least one concept represented by at least one node in the second semantic network representation.

25. The method of claim 24, further comprising assigning a score to each matched concept.

26. The method of claim 25, further comprising selecting one matched concept for the at least node in the first semantic network representation based bn the score for that one matched concept.

27. The method of claim 24, further comprising setting a threshold for a number of matched concepts found by a particular matching algorithm, and rejecting each matched concept found by that particular matching algorithm if the number exceeds the threshold.

28. The method of claim 17, wherein identifying semantic concept equivalencies includes generalizing at least one node of the first semantic network representation to find a concept in the second semantic network representation that encompasses a concept represented by the at least one node of the first semantic network representation.

29. The method of claim 17, wherein identifying semantic concept equivalencies includes decomposing at least one node of the first semantic network representation into constituent concepts and find a match for at least one of the constituent concepts in the second semantic network representation.

30. The method of claim 17, further comprising transmitting the request over a network to retrieve information from the second database.

31. The method of claim 17, further comprising storing the identified semantic concept equivalencies in the first database.

32. The method of claim 17, further comprising using a stored semantic concept equivalency to identify another semantic concept equivalency.

33. The method of claim 17, further comprising reconstructing the first semantic network representation if the first database changes.

34. The method of claim 17, further comprising dynamically re-identifying semantic concept equivalencies between the first semantic network representation and the second semantic network representation if one of the semantic network representations changes

35. A method of exchanging data between databases, the method comprising:
generating a semantic network representation of a first database; and
receiving a request from a remote database system to retrieve information from the first database, the request identifying a node of the semantic network representation; and
retrieving information from the first database using a query formulated from information associated with the node of the semantic network representation.

36. The method of claim 35, further comprising identifying semantic concept equivalencies between the semantic network representation of the first database and a second semantic network representation of a second database.

37. The method of claim 36, wherein identifying semantic concept equivalencies occurs in response to receiving the request from the remote database system.

38. The method of claim 36, further comprising receiving the second semantic network representation from the remote database system.

39. The method of claim 36, generating the semantic network representation of the first database occurs in response to receiving the request from the remote database system.

40. The method of claim 35, further comprising communicating the semantic network representation to the remote database system.

41. The method of claim 35, further comprising communicating the retrieved information to the remote database system over a network.

42. The method of claim 35, further comprising regenerating the first semantic network representation if the first database changes.
